(19) United States
(12) Patent Application Publication
(10) Pub. No.: US 2008/0295978 A1
(43) Pub. Date: Dec. 4, 2008

(54) Device and method for repairing a vertical louver

(76) Inventor: Brian A. Keasberry, Las Vegas, NV (US)

Correspondence Address: WEISS & MOY PC, 4204 NORTH BROWN AVENUE, SCOTTSDALE, AZ, 85251, US

(21) Appl. No.: 11/809,698

(22) Filed: Jun. 4, 2007

(51) Int. Cl. E06B 9/388

(52) U.S. Cl. 160/178.3

(57) ABSTRACT

A device and method permits repair of a vertical louver having a non-functioning opening. The device comprises a face having a replacement opening thereon, with the face being coupled to a vertical louver and positioned so that the replacement opening is substantially in the position of the non-functioning opening. Re-coupling of the vertical louver to a track through the replacement opening is then permitted.

### FIELD OF THE INVENTION

The present invention relates generally to vertical louvers and, more particularly, to a device and method for repairing a top opening portion of an individual vertical louver.

### BACKGROUND OF THE INVENTION

Vertical louvers or blinds consist of a plurality of plurality of louvers that are positioned vertically on a track. Each individual louver has, at an upper portion thereof, an opening. The opening permits attachment between each louver and a horizontally disposed track.

Often as a result of pulling on a louver, it is frequently the case that individual louvers become separated from the track. This can occur where a break or tear is created in the louver, extending from the opening to an upper margin of the louver. (See FIG. 2). Such a tear typically makes it impossible to couple the louver to the track. This requires either replacement of an individual louver or, where this is not possible, purchase of a new vertical blind system entirely. Generally, it is not convenient to replace individual louvers, and the usual response to a broken louver is either to tolerate a missing louver or to replace the assembly as a whole.

A need exists for a device and method that permits repair of an individual vertical blind or louver in the event of a tear from the opening to the upper margin. The present invention satisfies this need and provides other, related, advantages.

### SUMMARY OF THE INVENTION

In accordance with an embodiment of the present invention, a vertical louver repair device is provided. The device comprises, in combination: a face having a replacement opening thereon; and means for attaching the face to the upper portion of a vertical louver having thereon a non-functioning opening so that the replacement opening is substantially in the position of the non-functioning opening.

In accordance with another embodiment of the present invention, a vertical louver repair device is provided. The device comprises, in combination: a convex face having a replacement opening thereon; and means for attaching the face to the upper portion of a vertical louver having thereon a non-functioning opening so that the replacement opening may be position substantially in the position of the non-functioning opening; wherein the attachment means comprises a clip located at each marginal end of the face and configured to grasp marginal ends of the vertical louver.

In accordance with a further embodiment of the present invention, a method for repairing a vertical louver is disclosed. The method comprises: providing a face having a replacement opening thereon; attaching the face to the upper portion of a vertical louver having thereon a non-functioning opening so that the replacement opening is substantially in the position of the non-functioning opening; and coupling the vertical louver with the face thereon to a track through the replacement opening.

### BRIEF DESCRIPTION OF THE DRAWINGS

FIG. 1 is a perspective view of a louver repair device consistent with an embodiment of the present invention.

FIG. 2 is a perspective view of a louver with a tear from the opening to the upper margin.

FIG. 3 is a perspective, cross-sectional view of the torn louver of FIG. 2 with the device of FIG. 1 thereon.

### DETAILED DESCRIPTION OF THE PREFERRED EMBODIMENTS

Referring first to FIG. 2, an individual vertical louver 10 is shown. The louver 10 includes a louver body 12 terminating in an upper margin 14. An opening 16 is positioned proximate the upper margin 14. The opening 16 permits coupling of the louver 10 to a track (not shown).

As illustrated in FIG. 2, a tear has occurred in the opening 16. The effect of the tear has been to extend the opening all of the way to the upper margin 14. As a consequence, the opening 16 is non-functioning, preventing coupling of the louver 10 to the track (not shown).

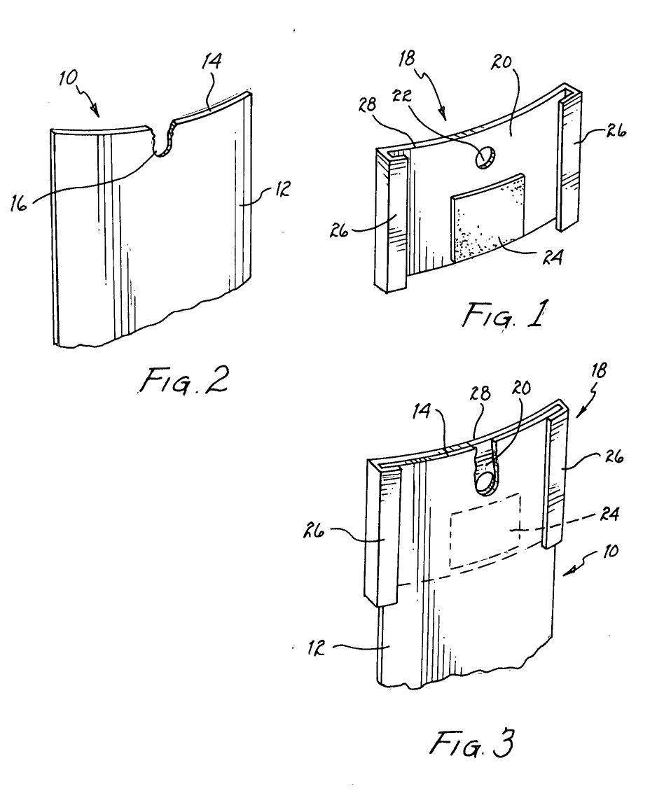

Referring now to FIG. 1, a louver repair device 18 consistent with an embodiment of the present invention is illustrated. The repair device 18, in one embodiment, comprises a face 20, a replacement opening 22 positioned on the face 20, adhesive means 24 located on the face 20 below the replacement opening 22, and clips 26 positioned at each end of the face 20. The repair device 18 has an upper margin 28. It will be desired to either provide a face 20 having the convexity of a typical louver 10 or, alternatively, to form the repair device 18 from a material that is sufficiently flexible to permit the face 20 to substantially conform to the convexity of the louver 10 to which it is to be attached.

As shown in FIG. 3, the repair device 18 is configured to be positioned at the top portion of atom louver 10. More specifically, in this embodiment, the repair device 18 is positioned so that the clips 26 may be slid over side portions of the louver 10, until the replacement opening 22 aligns with the opening 16. Such alignment may occur at a point where the upper margin 14 is substantially parallel with the upper margin 28, as shown in FIG. 3, or perhaps at some other position.

Retention of the repair device 18 to the louver 10 may be facilitated in a number of ways. The clips 26 may frictionally engage the side edges of the louver 10 with sufficient strength to remain in position relative to the louver 10 when the louver 10 is placed in position on a track (not shown). The adhesive means 24, when exposed and brought into contact with a surface portion of the louver body 12 as shown in FIG. 3, may additionally strength the bond between the repair device 18 and the louver 10. It should be noted that retention between the repair device 18 and the louver body 12 may be provided solely via the clips 26, solely by way of the adhesive means 24, by a combination of the clips 26 and adhesive mans 24, or by other desired means.

As shown in FIG. 3, when the repair device 18 is in position on the louver 10, the replacement opening 22 is positioned at the location of the opening 16, and acts to replace the opening 16. With the replacement opening 22 in position, it is now possible for the user to re-couple the louver 10 to the track (not shown).

It should be noted that louvers 10 may come in a variety of shapes and sizes, and it may be desired to provide repair devices 18 in a variety of shapes and sizes to match. In one embodiment, it may be desired to package a variety of differently sized and/or shaped repair devices 18 together for sale, to provide a user with increased repair flexibility.

Although particular embodiments of the invention have been described in detail for purposes of illustration, various modifications may be made without departing from the spirit and scope of the invention. Accordingly, the invention is not to be limited, except as by the appended claims.

I claim:

1. A vertical louver repair device comprising, in combination:
a face having a replacement opening thereon; and
means for attaching the face to the upper portion of a vertical louver having thereon a non-functioning opening so that the replacement opening is substantially in the position of the non-functioning opening.

2. The repair device of claim 1 wherein the attachment means comprises a clip located at each marginal end of the face and configured to grasp marginal ends of the vertical louver.

3. The repair device of claim 1 wherein the attachment means comprises an adhesive area located on the face.

4. The repair device of claim 2 wherein the attachment means further comprises an adhesive area located on the face.

5. The repair device of claim 1 wherein the face is convex.

6. A vertical louver repair device comprising, in combination:
a convex face having a replacement opening thereon; and
means for attaching the face to the upper portion of a vertical louver having thereon a non-functioning opening so that the replacement opening may be position substantially in the position of the non-functioning opening;
wherein the attachment means comprises a clip located at each marginal end of the face and configured to grasp marginal ends of the vertical louver.

7. The repair device of claim 6 wherein the attachment means further comprises an adhesive area located on the face.

8. A method for repairing a vertical louver comprising:
providing a face having a replacement opening thereon;
attaching the face to the upper portion of a vertical louver having thereon a non-functioning opening so that the replacement opening is substantially in the position of the non-functioning opening; and
coupling the vertical louver with the face thereon to a track through the replacement opening.

9. The method of claim 8 wherein the step of attaching comprises clipping the face to marginal ends of the vertical louver.

10. The method of claim 8 wherein the step of attaching comprises bringing an adhesive area located on the face into contact with a surface of the vertical louver.

11. The method of claim 9 wherein the step of attaching further comprises bringing an adhesive area located on the face into contact with a surface of the vertical louver.

12. The method of claim 8 wherein the face is convex.
